(19) United States
(12) Patent Application Publication
(10) Pub. No.: US 2025/0182930 A1
(43) Pub. Date: Jun. 5, 2025

(54) WIRE HARNESS

(71) Applicant: Proterial, Ltd., Tokyo (JP)

(72) Inventors: Tomoyuki MURAYAMA, Tokyo (JP); Yoshikazu HAYAKAWA, Hitachi-shi (JP); Hirotaka ESHIMA, Tokyo (JP)

(21) Appl. No.: 18/964,017

(22) Filed: Nov. 29, 2024

(30) Foreign Application Priority Data
Dec. 1, 2023 (JP) 2023-203849

(51) Int. Cl. H01B 7/40; B60R 16/02; H01B 7/00

(52) U.S. Cl. CPC H01B 7/40; B60R 16/0215; H01B 7/0045

(57) ABSTRACT

A wire harness includes a plurality of large-diameter wires, at least one multicore wire in which a plurality of small-diameter wires having a smaller outer diameter than the plurality of large-diameter wires are collectively covered with a sheath, and a holder to hold the plurality of large-diameter wires and the at least one multicore wire, wherein the plurality of large-diameter wires and the plurality of small-diameter wires are each formed by covering a conductor with an insulation, wherein the plurality of large-diameter wires and the at least one multicore wire are twisted together to form a twisted body, wherein the twisted body includes a portion in a longitudinal direction housed in the holder, and a portion not housed in the holder at which the plurality of large-diameter wires and the at least one multicore wire are exposed, wherein a length of a portion where the twisted body is housed in the holder is smaller than a length of a portion where the plurality of large-diameter wires and the at least one multicore wire are exposed, and wherein the insulation of each of the plurality of large-diameter wires and the sheath are in contact with each other at the portion housed in the holder.

### CROSS-REFERENCE TO RELATED APPLICATIONS

The present application is based on Japanese patent application No. 2023-203849 filed on Dec. 1, 2023, the entire contents of which are incorporated herein by reference.

### TECHNICAL FIELD

The present invention relates to a wire harness having plural electric wires.

### BACKGROUND OF THE INVENTION

Conventionally, wire harnesses having plural electric wires are used, e.g., in vehicles. A cable assembly described in Patent Literature 1 includes an electric parking brake cable having two electric parking brake wires and a jacket for electric parking brake covering these two electric parking brake wires, a wheel speed sensor cable having two wheel speed sensor wires and a jacket for wheel speed sensor covering these two wheel speed sensor wires, and a grommet as a binding member to bind the electric parking brake cable and the wheel speed sensor cable. The two electric parking brake wires and the two wheel speed sensor wires are connected, at one end, to a control device on the vehicle body-side through connectors. The other ends of the two electric parking brake wires are connected to a brake device through a connector, and a wheel speed sensor is attached to the other ends of the two wheel speed sensor wires.
Citation List Patent Literature 1: JP2021-121140A

### SUMMARY OF THE INVENTION

Cables having plural electric wires connecting the vehicle body-side to the wheel-side in vehicles, such as that described in Patent Literature 1, are bent and twisted in various directions due to movement of the wheels relative to the vehicle body and are thus desirably thin and highly flexible. The invention was made in view of such circumstances, and the object of the invention is to provide a wire harness that can be reduced in diameter and has excellent flexibility.

To solve the above problem, the invention provides a wire harness comprising: a plurality of large-diameter wires;
at least one multicore wire in which a plurality of small-diameter wires having a smaller outer diameter than the plurality of large-diameter wires are collectively covered with a sheath; and
a holder to hold the plurality of large-diameter wires and the at least one multicore wire, wherein the plurality of large-diameter wires and the plurality of small-diameter wires are each formed by covering a conductor with an insulation,
wherein the plurality of large-diameter wires and the at least one multicore wire are twisted together to form a twisted body,
wherein the twisted body comprises a portion in a longitudinal direction housed in the holder, and a portion not housed in the holder at which the plurality of large-diameter wires and the at least one multicore wire are exposed,
wherein a length of a portion where the twisted body is housed in the holder is smaller than a length of a portion where the plurality of large-diameter wires and the at least one multicore wire are exposed, and
wherein the insulation of each of the plurality of large-diameter wires and the sheath are in contact with each other at the portion housed in the holder.

### Advantageous Effects of the Invention

According to the invention, it is possible to provide a wire harness that can be reduced in diameter and has excellent in flexibility.

### BRIEF DESCRIPTION OF DRAWINGS

FIG. 1 is a configuration diagram illustrating a wire harness in the first embodiment of the present invention.

FIG. 2 is a cross-sectional view showing the wire harness taken along line A-A in FIG. 1.

FIG. 3A is a cross-sectional view showing a power line.

FIG. 3B is a cross-sectional view showing a multicore wire.

FIG. 4 is a cross-sectional view showing a holder and a twisted body in the second embodiment.

FIG. 5 is a cross-sectional view showing the holder and the twisted body in the third embodiment.

FIG. 6 is a cross-sectional view showing the holder and the twisted body in the fourth embodiment.

### DETAILED DESCRIPTION OF THE INVENTION

### First Embodiment

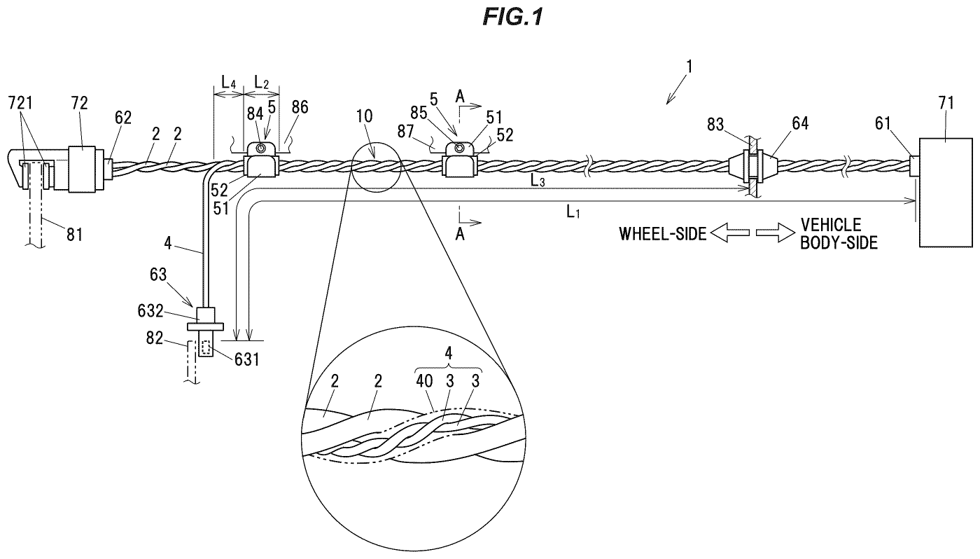

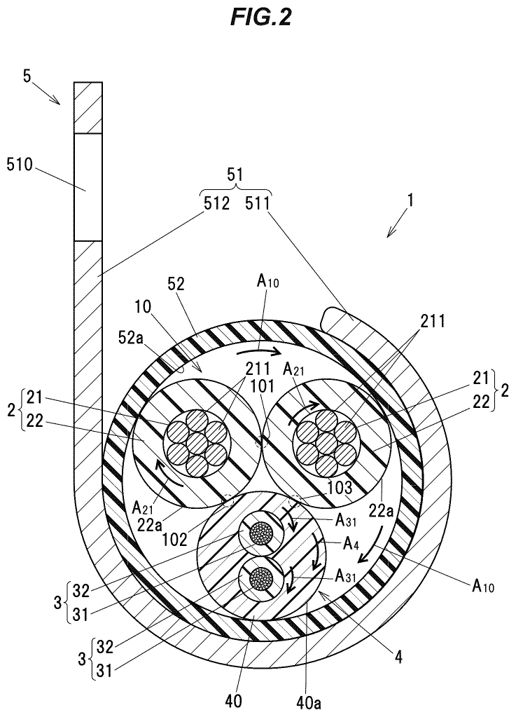

FIG. 1 is a configuration diagram illustrating a wire harness 1 in the first embodiment of the invention. FIG. 2 is a cross-sectional view showing the wire harness 1 taken along line A-A in FIG. 1. The wire harness 1 is installed in a vehicle and routed between the vehicle body-side and the wheel-side. Next, a configuration of the wire harness 1 will be described in detail.

The wire harness 1 includes plural power lines 2, a multicore wire 4 in which plural signal lines 3 are covered with a sheath 40, plural holders 5 to hold the plural power lines 2 and the multicore wire 4, a batch connector (multi-wire connector) 61 provided at the vehicle body-side ends of the plural power lines 2 and the multicore wire 4, a power line connector 62 provided at the wheel-side ends of the plural power lines 2, a sensor head 63 provided at the wheel-side end of the multicore wire 4, and a grommet 64.

The batch connector 61 is connected to a control device 71 arranged on the vehicle body-side. A connection cable may connect the batch connector 61 and the control device 71. The power line connector 62 is connected to an electric braking device 72. The plural power lines 2 supply operating power to the electric braking device 72 through the power line connector 62. The braking device 72 is, e.g., an electric parking brake device that locks rotation of the wheel when the vehicle is stopped, but the braking device 72 is not limited thereto and may be an electric braking device (electric servo braking system) that applies a brake to the wheel when the vehicle is in motion. The braking device 72 has a pair of pads 721 and, when activated, generates a frictional force by pressing the pair of pads 721 against a brake disc 81.

The sensor head 63 has a physical quantity sensor 631 to detect a physical quantity, and a resin molded body 632 that is made of a molding resin and covers the physical quantity sensor 631 and an end portion of the sheath 40. As the molding resin, it is possible to suitably use, e.g., polyamide (PA), polybutylene terephthalate (PBT), etc. The plural signal lines 3 are, inside the resin molded body 632, led out of the sheath 40 and connected to the physical quantity sensor 631. In the first embodiment, the physical quantity sensor 631 is a magnetic field sensor that detects the direction and strength of a magnetic field, and detects a magnetic field of a disk-shaped magnetic encoder 82 that rotates together with the wheel. The control device 71 can obtain a rotation speed of the wheel based on a detection signal of the physical quantity sensor 631 transmitted through the plural signal lines 3.

The grommet 64 is made of, e.g., a rubber material such as EPDM (ethylene propylene diene rubber) and is attached to a wheel well cover 83. The plural power lines 2 and the multicore wire 4 are inserted through the grommet 64. The grommet 64 deters an ingress of foreign matter such as dust and moisture into the vehicle body-side relative to the wheel well cover 83. The grommet 64 is a cylindrical member, and the plural power lines 2 and the multicore wire 4 are in contact with an inner circumferential surface of the grommet 64.

In the first embodiment, the wire harness 1 has two power lines 2 and one multicore wire 4. The two power lines 2 and the one multicore wire 4 are twisted together to form a twisted body 10. However, the numbers of the power lines 2 and the multicore wires 4 are not limited thereto, and the number of the power lines 2 may be three or more, and the number of the multicore wires 4 may be two or more. In FIG. 2, a twisting direction of the two power lines 2 and the one multicore wire 4 is indicated by an arrow A₁₀.

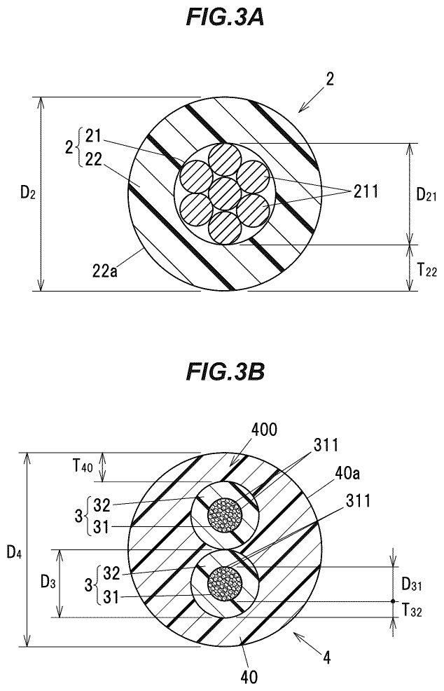

FIG. 3A is a cross-sectional view showing the power line 2. The power line 2 is an insulated wire in which a conductor 21 is covered with an insulation 22. The conductor 21 is a stranded wire formed by twisting together plural strands 211 made of a highly conductive metal such as copper. In the first embodiment, the conductor 21 is composed of seven strands 211 twisted together. In FIG. 2, a twisting direction of the plural strands 211 in the power line 2 is indicated by an arrow A₂₁. In FIG. 3A, an outer diameter of the power line 2, a conductor diameter of the conductor 21 and a thickness of the insulation 22 are respectively denoted by D₂, D₂₁, and T₂₂. The outer diameter D₂ of the power line 2 is, e.g., 4.0 mm. The conductor diameter D₂₁ of the conductor 21 is, e.g., 2.1 mm. The thickness T₂₂ of the insulation 22 is, e.g., 0.95 mm.

FIG. 3B is a cross-sectional view showing the multicore wire 4. In the first embodiment, the multicore wire 4 has two signal wires 3 which are collectively covered with the sheath 40. The two signal wires 3 are twisted together inside the sheath 40. FIG. 1 shows a portion of the twisted body 10 enlarged in an enlarged portion. In this enlarged portion, the outline of the sheath 40 is shown by phantom lines (dash-dot-dot lines), and the two signal lines 3 are shown by solid lines. The sheath 40 gets into a valley portion formed between the two signal wires 3 in contact with each other, and the multicore wire 4 is an electric wire having a so-called solid (non-hollow) structure.

The signal line 3 is an insulated wire in which a conductor 31 is covered with an insulation 32. The conductor 31 is a stranded wire formed by twisting together plural strands 311 made of a highly conductive metal such as copper. In first embodiment, the conductor 31 is formed by twisting forty strands 311 together. In FIG. 2, a twisting direction of the two signal lines 3 in the multicore wire 4 is indicated by an arrow A₄, and a twisting direction of the plural strands 311 in the signal line 3 is indicated by an arrow A₃₁.

In FIG. 3B, an outer diameter of the multicore wire 4, an outer diameter of the signal line 3, a conductor diameter of the conductor 31 and a thickness of the insulation 32 are respectively denoted by D₄, D₃, D₃₁, and T₃₂. The outer diameter D₄ of the multicore wire 4 is, e.g., 4.0 mm. The outer diameter D₃ of the signal line 3 is, e.g., 1.4 mm. The conductor diameter D₃₁ of the conductor 31 is, e.g., 0.7 mm. The thickness T₃₂ of the insulation 32 is, e.g., 0.35 mm. In addition, a thickness T₄₀ of a thinnest portion 400 of the sheath 40 in a radial direction of the multicore wire 4 is smaller than the thickness T₂₂ of the insulation 22, and is, e.g., 0.6 mm. A width W of the two signal lines 3 in an alignment direction of the two signal lines 3 is larger than the conductor diameter D₂₁ of the conductor 21 and is, e.g., 2.8 mm.

The outer diameter D₃ of the signal line 3 is smaller than the outer diameter D₂ of the power line 2. The power line 2 corresponds to the large-diameter wire of the invention, and the signal line 3 corresponds to the small-diameter wire of the invention. The outer diameter D₂ of each of the plural power lines 2 is approximately the same as the outer diameter D₄ of the multicore wire 4. In more particular, the outer diameter D₄ of the multicore wire 4 is 95% or more and 105% or less of the outer diameter D₂ of the power line 2. The configuration in which the thickness T₄₀ of the thinnest portion 400 of the sheath 40 is smaller than the thickness T₂₂ of the insulator 22 contributes to making the outer diameter D₂ of the power line 2 and the outer diameter D₄ of the multicore wire 4 approximately the same.

The insulation 22 of each of the plural power lines 2 and the sheath 40 of the multi-core wire 4 are configured such that at least the outermost layer is made of a polyurethane-based resin. It is thereby possible to suppress occurrence of damage to the plural power lines 2 and the multicore wire 4 caused by kicked-up stones, etc. The polyurethane-based resin is a resin obtained by polymerization reaction between an isocyanate compound and a hydroxyl group component. In the first embodiment, the insulation 22 of the power line 2 and the sheath 40 of the multicore wire 4 are entirely made of a polyurethane-based resin. However, it is not limited thereto, and either or both of the insulation 22 and the sheath 40 may have a multilayer structure in which plural types of resin layers are stacked, as long as the outermost layers of the insulation 22 and the sheath 40 are made of a polyurethane-based resin. For example, when the insulation 22 of the power line 2 has a two-layer structure which has an inner layer made of polyethylene and an outer layer made of a polyurethane-based resin, the insulating properties of the power line 2 can be enhanced due to the high electrical insulating properties of the polyethylene. In this case, from the viewpoint of the insulating properties, the thickness of the inner layer made of polyethylene is preferably larger than the thickness of the outer layer made of a polyurethane-based resin. In the first embodiment, the high electrical insulating properties mean that volume resistivity is high. The inner layer may be made of a material other than polyethylene (e.g., polyvinyl chloride (PVC), polypropylene (PP), polystyrene (PS), etc.) as long as the material has higher volume resistivity than the polyurethane-based resin.

An outer circumferential surface 22a of the insulation 22 of each of the plural power lines 2 and an outer circumferential surface 40a of the sheath 40 of the multicore wire 4 have a surface roughness Ra (an arithmetic average roughness defined by JIS B0601 (2013)) of 1 μm or more. This surface roughness can be achieved by adjusting the conditions such as the extrusion temperature when forming the insulation 22 and the sheath 40. Alternatively, after forming the insulation 22 and the sheath 40, chemical or mechanical treatment may be performed so that the outer circumferential surfaces 22a and 40a have a surface roughness Ra of 1 μm or more. A more preferable range of the surface roughness Ra of the outer circumferential surface 22a of the insulation 22 of each of the plural power lines 2 and the outer circumferential surface 40a of the sheath 40 of the multicore wire 4 is 4 μm or more and 15 μm or less.

The holder 5 has a tightening member 51 that tightens on the twisted body 10. The tightening member 51 is made of, e.g., a metal and is tightly wound so as to surround the outer circumference of the twisted body 10. The tightening member 51 has a surrounding portion 511 curved to surround the twisted body 10, and a fixing portion 512 for fixing to an attachment target. In a cross section perpendicular to a longitudinal direction of the twisted body 10, the tightening member 51 has a shape in which the surrounding portion 511 has an arc shape and the fixing portion 512 has a flat plate shape, as shown in FIG. 2. The tightening member 51 is formed by, e.g., plastically deforming a portion of a flat metal plate into a curve, and this curved portion serves as the surrounding portion 511. The fixing portion 512 has a through-hole 510 through which a fastener such as a bolt for fixing the holder 5 is inserted.

In the first embodiment, the holder 5 has a resin tube 52 having a cylindrical shape, and the resin tube 52 surrounds the twisted body 10 on the inner side of the surrounding portion 511 of the tightening member 51. The tightening member 51 tightens on the resin tube 52 toward the twisted body 10. The tightening force of the tightening member 51 to tighten on the resin tube 52 is, e.g., 10 N or more. The twisted body 10 is tightened by the tightening member 51 with the resin tube 52 therebetween, and pressure is applied so that the plural power lines 2 and the multicore wire 4 come into contact with each other. The tightening member 51 is in contact with the resin tube 52. The resin tube 52 is in contact with the plural power lines 2 and the multicore wire 4. A length of the resin tube 52 is greater than a width of the tightening member 51, and in FIG. 1, the resin tube 52 protrudes from both sides of the tightening member 51.

The resin tube 52 is made of, e.g., a polyurethane-based resin similar to that used for the insulation 22 of each of the plural power lines 2 and the sheath 40 of the multicore wire 4, or a rubber material such as EPDM (ethylene propylene diene rubber). The resin tube 52 has an inner circumferential surface 52a with a surface roughness Ra of 1 μm or more. For the inner circumferential surface 52a of the resin tube 52, the surface roughness Ra can also be increased, e.g., by roughening the surface of a mold used to mold the resin tube 52. A desirable range of the surface roughness Ra of the inner circumferential surface 52a of the resin tube 52 is 1 μm or more and 30 μm or less, and a more desirable range is 4 μm or more and 15 μm or less. By increasing the surface roughness of the inner circumferential surface 52a of the resin tube 52, positional shift of the plural power lines 2 and the multicore wire 4 relative to the resin tube 52 can be suppressed by an anchor effect.

The respective insulations 22 of the plural power lines 2 and the sheath 40 of the multicore wire 4 are in contact with each other at a portion housed in the holder 5. In FIG. 2, a contact portion 101 between the insulation 22 of one power line 2 and the insulation 22 of the other power line 2, a contact portion 102 between the insulation 22 of the one power line 2 and the sheath 40 of the multicore wire 4, and a contact portion 103 between the insulation 22 of the other power line 2 and the sheath 40 of the multicore wire 4 are each surrounded by a dashed line.

A portion of the twisted body 10 in the longitudinal direction is housed in the holder 5. At the portion not housed in the holder 5, the twisted body 10 is not covered with an outer covering such as a sheath and the plural power lines 2 and the multicore wire 4 are exposed. That is, on the inner side of the wheel well cover 83, the plural power lines 2 and the multicore wire 4, which are twisted together, are uncovered, except for the portion where the twisted body 10 is housed in the holder 5.

In the longitudinal direction of the twisted body 10, a length of the portion where the twisted body 10 is housed in the holder 5 is shorter than a length of the portion where the plural power lines 2 and the multicore electric wire 4 are exposed. In other words, the length of the portion where the twisted body 10 is housed in the holder 5 is less than half the entire length of the twisted body 10. The entire length of the twisted body 10 here is a length between an end of any of the plural power lines 2 and the multicore wire 4 that is located farthest from a holder 5 on one side of the holder 5 in the longitudinal direction of the twisted body 10, and an end of any of the plural power lines 2 and the multicore wire 4 that is located farthest from the holder 5 on the other side of the holder 5 in the longitudinal direction of the twisted body 10. In the first embodiment, although the wire harness 1 has plural holders 5, the entire length of the twisted body 10 is the same based on any of the holders 5 since the plural power lines 2 and the multicore wire 4 are twisted together between the holders 5.

In the example shown in FIG. 1, since the multicore wire 4 is longer than the power lines 2, a length L₁ from the batch connector 61 to the sensor head 63 is the entire length of the twisted body 10. When the length of the portion where the twisted body 10 is housed in the holder 5 is defined as L₂, L₂ is less than 50% of L₁. L₁ is, e.g., 1.0 m or more and 1.5 m or less, and L₂ is, e.g., 2 cm or more and 3 cm or less. In the first embodiment, L₂ is the length of the resin tube 52 in the longitudinal direction of the twisted body 10.

In the first embodiment, the twisted body 10 is held by two holders 5 at two locations in the longitudinal direction. These holders 5 are fixed to attachment target members 86, 87 by bolts 84, 85 as fasteners. The attachment target members 86, 87 are, e.g., a component (suspension arm, knuckle arm, link, strut, etc.) of a suspension device, or a so-called unsprung member such as hub unit. The attachment target member 86 to which one of the two holders 5, which is closer to the wheel, is attached is a member (e.g., a knuckle arm or a hub unit) whose position relative to the braking device 72 does not change even when the wheel moves relative to the vehicle body. The attachment target member 87 to which the other holder 5 is attached is, e.g., a member that moves a smaller amount relative to the vehicle body than relative to the braking device 72 when the wheel moves relative to the vehicle body. However, it is not limited thereto. The amounts that the attachment target members 86 and 87 move relative to the vehicle body when the wheel moves relative to the vehicle body may be the same.

The number of the holders 5 included in the wire harness 1 is not limited to two, and may be one, or three or more. In addition, although the twisted body 10 in the first embodiment is held by the holders 5 at two locations on the wheel-side relative to the grommet 64 attached to the wheel well cover 83, the twisted body 10 may also be held by one or plural holders 5 on the vehicle body-side relative to the grommet 64. Furthermore, on the vehicle body-side relative to the grommet 64, the plural power lines 2 and the multicore wire 4 do not need to be twisted together. In other words, the plural power lines 2 and the multicore wire 4 of the twisted body 10 only need to be twisted together at least at a portion on the wheel-side.

In the twisted body 10, the two power lines 2 and the multicore wire 4 are twisted together at least at the portion held by the holder 5, and the power lines 2 and the multicore wire 4 are untwisted on an end side (the wheel-side) relative to the portion housed in the holder 5. The plural power lines 2 and the multicore wire 4 on the end side relative to the holder 5 have a portion remaining twisted together at least at an end on the holder 5 side. In the case where the twisted body 10 is held by plural holders 5 as in the first embodiment, the plural power lines 2 and the multicore wire 4 are untwisted on the end side relative to the holder 5 closest to the wheel among the plural holders 5, and the plural power lines 2 and the multicore wire 4 remain twisted together in a range of a length L₄ on the end side relative to the holder 5 closest to the wheel as shown in FIG. 1. In other words, the plural power lines 2 and the multicore wire 4 remain twisted together between a position where the plural power lines 2 and the multicore wire 4 are untwisted (the plural power lines 2 and the multicore wire 4 are branched off), and the holder 5 closest to the wheel among the plural holders 5. This suppresses the deformation of an end portion of the resin tube 52 (on the side where the plural power lines 2 and the multicore wire 4 are branched off) when, e.g., the plural power lines 2 and the multicore wire 4 need to be branched off at a steep angle.

### Effects of the First Embodiment

In the first embodiment described above, the twisted body 10 is housed in the holders 5 at portions in the longitudinal direction, and the plural power lines 2 and the multicore wire 4 are exposed at the other portions. Therefore, as compared to the case where, e.g., the plural power lines 2 and the multicore wire 4 are covered with an outer covering such as a sheath, the wire harness 1 can be reduced in diameter and can be more flexible at the portions where the plural power lines 2 and the multicore wire 4 are exposed.

In addition, in the first embodiment, the respective insulations 22 of the plural power lines 2 and the sheath 40 of the multicore wire 4, which are made of a polyurethane-based resin, are in contact with each other at the portions housed in the holders 5, hence, misalignment between the plural power lines 2 and the multicore wire 4 is less likely to occur. The use of adhesive polyurethane as the polyurethane-based resin is particularly desirable to suppress misalignment between the plural power lines 2 and the multicore wire 4 at the portions housed in the holders 5.

In addition, in the first embodiment, the outer circumferential surface 22a of the insulation 22 of each of the plural power lines 2 and the outer circumferential surface 40a of the sheath 40 of the multicore wire 4 have a surface roughness Ra of 1 μm or more. Therefore, the plural power lines 2 and the multicore wire 4 are likely to slip relative to each other at the portions where the plural power lines 2 and the multicore wire 4 are exposed, and the twisted body 10 flexes flexibly with movement of the wheel relative to the vehicle body during when the vehicle is in motion.

In addition, in the first embodiment, since the twisting direction of the two power lines 2 and the multicore wire 4 indicated by the arrow A₁₀ is the same as the twisting direction of the two signal lines 3 in the multicore wire 4 indicated by the arrow A₄, the two power lines 2 and the multicore wire 4 are unlikely to be unraveled even when the wheel moves relative to the vehicle body and contact of the power line 2 or the multicore wire 4 with, e.g., a component of the suspension device is suppressed. Furthermore, in the first embodiment, the twisting direction of the plural strands 211 in the power line 2 indicated by the arrow A₂₁ and the twisting direction of the plural strands 311 in the signal line 3 indicated by the arrow A₃₁ are the same as the twisting direction of the two power lines 2 and the multicore wire 4 and the twisting direction of the two signal lines 3 in the multicore wire 4 (the clockwise direction in FIG. 2), which further enhances the effect of making the two power lines 2 and the one multicore wire 4 less likely to be unraveled.

In addition, in the first embodiment, the outer diameter D₂ of each of the plural power lines 2 and the outer diameter D₄ of the multicore wire 4 are approximately the same. Therefore, as compared to the case where these outer diameters are greatly different, it is possible to make the tightening force of the tightening member 51 evenly act on the plural power lines 2 and the multicore wire 4, thereby increasing the reliability of holding the twisted body 10 by the holder 5.

In addition, in the first embodiment, since the resin tube 52 is interposed between the surrounding portion 511 of the tightening member 51 of the holder 5 and the twisted body 10, the positions of the two power lines 2 and the multicore wire 4 are less likely to shift relative to the holder 5, and damage to the two power lines 2 and the multicore wire 4 due to contact with the tightening member 51 is suppressed.

In this regard, the resin tube 52 may have a shape with a slit formed along the longitudinal direction of the resin tube 52 at one location in the circumferential direction as long as the resin tube 52 has a cylindrical shape when combined with the tightening member 51 and holding the twisted body 10. In this case, the twisted body 10 can be placed inside the resin tube 52 while pushing and widening the slit, which improves assembly workability of the holder 5.

### Second Embodiment

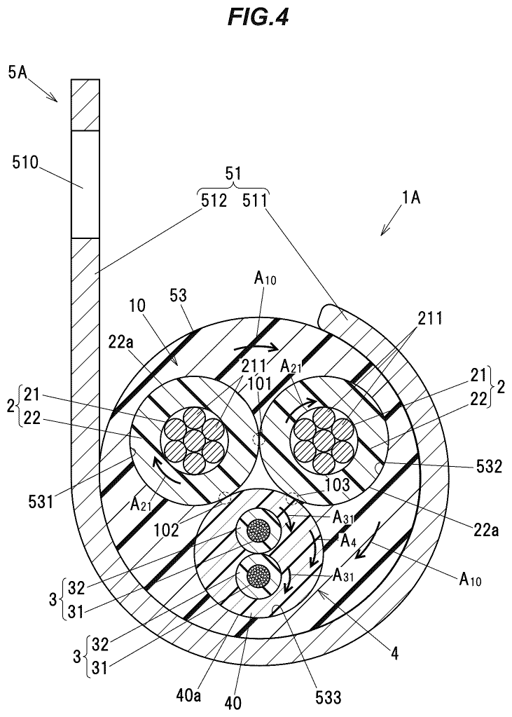

Next, a wire harness 1A in the second embodiment of the invention will be described with reference to FIG. 4. FIG. 4 is a cross-sectional view showing a holder 5A of the wire harness 1A and the twisted body 10 held by the holder 5A in the second embodiment. The number and attachment positions of the holders 5A in the wire harness 1A and the length L₂ of the twisted body 10 held by the holder 5A are, e.g., the same as those in the first embodiment described with reference to FIG. 1. The same applies to the other embodiments described later.

The example in which the holder 5 has the tightening member 51 and the resin tube 52 has been described the first embodiment. In the second embodiment, the holder 5A has the same tightening member 51 as that of the holder 5 in the first embodiment and has a resin molded body 53 in place of the resin tube 52. The resin molded body 53 has holding holes 531, 532, and 533 that are formed to penetrate the resin molded body 53 in the longitudinal direction of the twisted body 10 and respectively hold the plural power lines 2 and the multicore wire 4. The tightening member 51 tightens on the resin molded body 53 from the outer periphery toward the twisted body 10. The twisted body 10 is tightened by the tightening member 51 through the resin molded body 53.

The resin molded body 53 is made of a molding resin that is molded so as to be in tight contact with the outer circumferential surface 22a of the insulation 22 of each of the plural power lines 2 and the outer circumferential surface 40a of the sheath 40 of the multicore wire 4. A material used as this molding resin can be, e.g., a polyurethane-based resin, but is not limited thereto and may be, e.g., a rubber material such as EPDM. The plural power lines 2 and the multicore wire 4 are twisted together at the portion held by the holder 5A. The surface roughness Ra of the outer circumferential surface 22a of the insulation 22 of each of the plural power lines 2 and the outer circumferential surface 40a of the sheath 40 of the multicore wire 4 is the same as that in the first embodiment.

The tightening force of the tightening member 51 to tighten on the resin molded body 53 is, e.g., the same as that in the first embodiment, but may be smaller than that in the first embodiment since the positions of the plural power lines 2 and the multicore wire 4 are less likely to shift relative to the holder 5A due to the configuration in which the resin molded body 53 is in tight contact with the outer circumferential surface 22a of the insulation 22 of each of the plural power lines 2 and the outer circumferential surface 40a of the sheath 40 of the multicore wire 4. The tightening force of the tightening member 51 of the holder 5A is, e.g., 10 N or more.

The second embodiment also provides the same effects as the first embodiment. In addition, the twisted body 10 can be held more reliably by the holder 5A.

### Third Embodiment

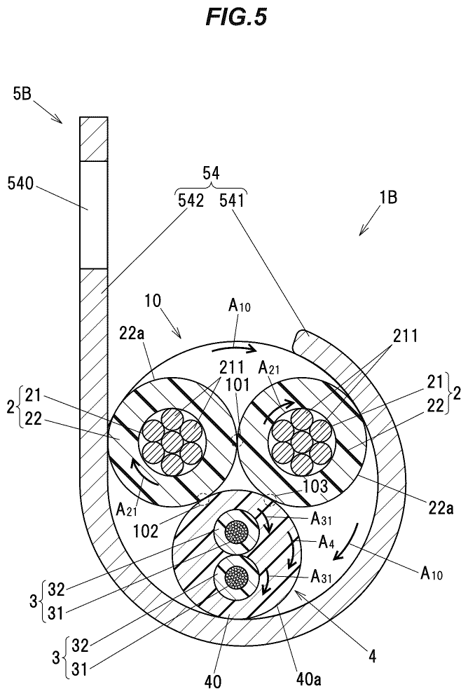

Next, a wire harness 1B in the third embodiment of the invention will be described with reference to FIG. 5. FIG. 5 is a cross-sectional view showing a holder 5B of the wire harness 1B and the twisted body 10 held by the holder 5B in the third embodiment.

In the third embodiment, the holder 5B consists of a tightening member 54 and does not have members corresponding to the resin tube 52 or the resin molded body 53, and the twisted body 10 is directly tightened by the tightening member 54. The tightening member 54 integrally has a surrounding portion 541 curved to surround the twisted body 10, and a fixing portion 542 for fixing to an attachment target, and the fixing portion 542 has a through-hole 540 through which a fastener such as a bolt is inserted, in the same manner as the tightening member 51 in the first embodiment.

Also in the third embodiment, by appropriately selecting the attachment position of the holder 5B on the vehicle, it is possible to hold the twisted body 10 with the tightening members 54 while suppressing damage to the power line 2 or the multicore wire 4 due to contact with the tightening members 54. Also in the third embodiment, the plural power lines 2 and the multicore wire 4 remain twisted together between a position where the plural power lines 2 and the multicore wire 4 are untwisted (the plural power lines 2 and the multicore wire 4 are branched off), and the holder 5B closest to the wheel. It is thereby possible to suppress damage to the plural power lines 2 and the multicore wire 4 caused by an end portion of the holder 5B (on the side where the plural power lines 2 and the multicore wire 4 are branched off) when, e.g., the plural power lines 2 and the multicore wire 4 need to be branched off at a steep angle.

### Fourth Embodiment

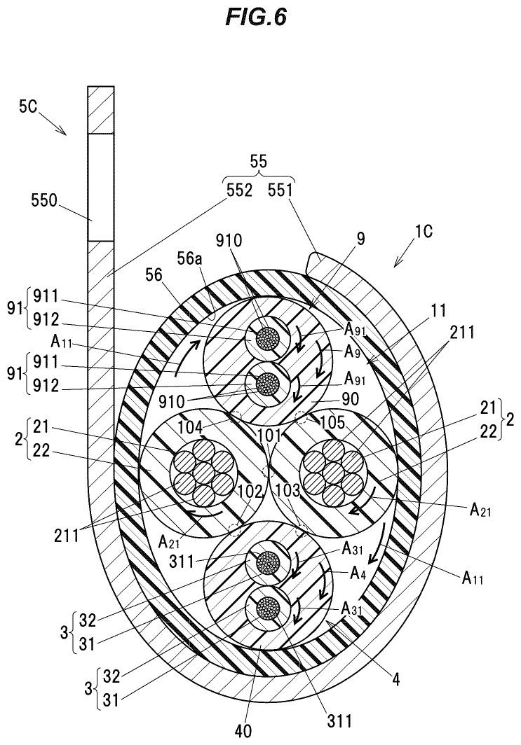

Next, a wire harness 1C in the fourth embodiment of the invention will be described with reference to FIG. 6. FIG. 6 is a cross-sectional view showing a holder 5C of the wire harness 1C and a twisted body 11 held by the holder 5C in the fourth embodiment.

The twisted body 11 in the fourth embodiment has, in addition to the two power lines 2 and the one multicore wire 4 in the twisted body 10 of the first to third embodiments, a multicore wire 9 configured in the same manner as the multicore wire 4. The two power lines 2 and the multicore wires 4 and 9 are twisted together in a direction indicated by an arrow A₁₁ shown in FIG. 6 to form the twisted body 11. The twisted body 11 is held by the holder or holders 5C at one or plural locations in the longitudinal direction.

The multicore wire 9 has two insulated wires 91 as the small-diameter wires of the invention, and a sheath 90 collectively covering the two insulated wires 91. The insulated wire 91 is configured such that a conductor 911 is covered with an insulation 912. The conductor 911 is a stranded wire formed by twisting together plural strands 910 made of a highly conductive metal such as copper. The respective dimensions and materials of the sheath 90 and the two insulated wires 91 in the multicore wire 9 and the surface roughness of an outer circumferential surface 90a of the sheath 90 are the same as the respective dimensions and materials of the sheath 40 and the two signal wires 3 in the multicore 4 and the surface roughness of the outer circumferential surface 40a of the sheath 40 described in the first embodiment. A twisting direction of the two insulated wires 91 in the multicore wire 9 indicated by an arrow A₉, a twisting direction of the plural strands 910 in the multicore wire 9 indicated by an arrow A₉₁, the twisting direction of the two signal lines 3 in the multicore wire 4 indicated by the arrow A₄, and the twisting direction of the plural strands 311 in the signal line 3 indicated by the arrow A₃₁ are the same as a twisting direction of the two power lines 2 and the multicore wires 4 and 9.

The insulated wire 91 is used as, e.g., a power line or signal line for an electronic component such as a sensor that detects a state of the wheel. Examples of this sensor include an air pressure sensor to detect air pressure in a tire, and an acceleration sensor to control a damper with adjustable damping force. In addition, the insulated wire 91 may be used to control the braking device 72 to which operating power is supplied through the power line 2, or the multicore wire 9 can be connected in parallel with the multicore wire 4 to the physical quantity sensor 631 and used to provide redundancy of the multicore wire 4.

The holder 5C has a tightening member 55 and a resin tube 56 having a cylindrical shape. The tightening member 55 has a surrounding portion 551 curved to surround the twisted body 11 and the resin tube 56, and a fixing portion 552 for fixing to an attachment target. The fixing portion 552 has a through-hole 550 through which a fastener such as a bolt is inserted. The materials of the tightening member 55 and the resin tube 56 are the same as the materials of the tightening member 51 and the resin tube 52 of the holder 5 described in the first embodiment.

The resin tube 56 has an inner circumferential surface 56a that is in contact with the two power lines 2 and the multicore wires 4 and 9. The surface roughness Ra of the inner circumferential surface 56a of the resin tube 56 is 1 μm or more. A desirable range of the surface roughness Ra of the inner circumferential surface 56a of the resin tube 56 is 1 μm or more and 30 μm or less, and a more desirable range is 4 μm or more and 15 μm or less.

In the example shown in FIG. 6, at the portion where the twisted body 11 is held by the holder 5C, the two power lines 2 are in contact with each other, the multicore wire 4 is in contact with the two power lines 2, and the multicore wire 9 is in contact with the two power lines 2. In FIG. 6, a contact portion 101 between the insulation 22 of one power line 2 and the insulation 22 of the other power line 2, contact portions 102, 104 between the insulation 22 of the one power line 2 and the sheaths 40, 90 of the multicore wires 4, 9, and contact portions 103, 105 between the insulation 22 of the other power line 2 and the sheaths 40, 90 of the multicore wires 4, 9 are each surrounded by a dashed line.

However, the configuration is not limited thereto and may be such that the multicore wires 4, 9 are in contact with each other and the two power lines 2 are respectively in contact with the multicore wires 4, 9. In this regard, in the first embodiment, the cross-sectional shape of the resin tube 52 is a circular shape. In the fourth embodiment, the cross-sectional shape of the resin tube 56 is an elliptical shape and the cross-sectional shape of the surrounding portion 551 of the tightening member 55 is also an elliptical shape that corresponds to the shape of the resin tube 56.

In the twisted body 11, the plural power lines 2 and the multicore wires 4, 9 are untwisted on an end side relative to the portion housed in the holder 5C, and the plural power lines 2 and the multicore wires 4, 9 on the end side relative to the holder 5C has a portion remaining twisted together at least at an end on the holder 5C side.

The fourth embodiment also provides the same effects as the first embodiment. In the fourth embodiment, for example, a molded body formed by molding a molding resin as in the second embodiment may be used in place of the resin tube 56. In addition, for example, as in the third embodiment, the resin tube 56 may be omitted and the twisted body 11 may be directly tightened by the tightening member 55.

### SUMMARY OF THE EMBODIMENTS

Technical ideas understood from the embodiments will be described below citing the reference signs, etc., used for the embodiments. However, each reference sign described below is not intended to limit the constituent elements in the claims to the members, etc., specifically described in the embodiments.

According to the first feature, a wire harness 1, 1A, 1B, 1C comprising: a plurality of large-diameter wires (the power lines 2); at least one multicore wire 4, 9 in which a plurality of small-diameter wires (the signal lines 3, the insulated wires 91) having a smaller outer diameter than the plurality of large-diameter wires (the power lines 2) are collectively covered with a sheath 40, 90; and a holder 5, 5A, 5B, 5C to hold the plurality of large-diameter wires 2 and the at least one multicore wire 4, 9, wherein the plurality of large-diameter wires 2 and the plurality of small-diameter wires 3, 91 are each formed by covering a conductor 21, 31, 911 with an insulation 22, 32, 912, wherein in the insulation 22 of each of the plurality of large-diameter wires 2 and the sheath 40, 90, at least an outermost layer comprises a polyurethane-based resin, wherein the plurality of large-diameter wires 2 and the at least one multicore wire 4, 9 are twisted together to form a twisted body 10, 11, wherein the twisted body 10, 11 comprises a portion in a longitudinal direction housed in the holder 5, 5A, 5B, 5C, and a portion not housed in the holder 5, 5A, 5B, 5C at which the plurality of large-diameter wires 2 and the at least one multicore wire 4, 9 are exposed, wherein a length of a portion where the twisted body 10, 11 is housed in the holder 5, 5A, 5B, 5C is smaller than a length of a portion where the plurality of large-diameter wires 2 and the at least one multicore wire 4, 9 are exposed, and wherein the insulation 22 of each of the plurality of large-diameter wires 2 and the sheath 40 are in contact with each other at the portion housed in the holder 5, 5A, 5B, 5C.

According to the second feature, in the wire harness 1, 1A, 1B, 1C as described by the first feature, the insulation 22 of each of the plurality of large-diameter wires 2 and the sheath 40, 90 have an outer circumferential surface 22a, 40a, 90a with a surface roughness Ra of 1 μm or more.

According to the third feature, in the wire harness 1, 1A, 1B, 1C as described by the first feature, the plurality of small-diameter wires 3, 91 of the at least one multicore wire 4, 9 are twisted together inside the sheath 40, 90, and wherein a twisting direction of the plurality of small-diameter wires 3, 91 is the same as a twisting direction of the plurality of large-diameter wires 2 and the at least one multicore wire 4, 9 in the twisted body 10, 11.

According to the fourth feature, in the wire harness 1, 1A, 1B, 1C as described by the first feature, an outer diameter of each of the plurality of large-diameter wires 2 is approximately the same as an outer diameter of the at least one multicore wire 4, 9.

According to the fifth feature, in the wire harness 1, 1A, 1B, 1C as described by any one of the first to third features, the holder 5, 5A, 5B, 5C comprises a tightening member 51, 54, 55 that tightens on the twisted body 10, 11.

According to the sixth feature, in the wire harness 1, 1C as described by any one of the first to third features, the holder 5, 5C comprises a resin tube 52, 56 that surrounds the twisted body 10, 11, and a tightening member 51, 55 that tightens on the resin tube 52, 56.

According to the seventh feature, in the wire harness 1B as described by any one of the first to third features, the holder 5A comprises a resin molded body 53 comprising holding holes 531, 532, 533 formed to penetrate therethrough to respectively hold the plurality of large-diameter wires 2 and the at least one multicore wire 4, and a tightening member 51 that tightens on the resin molded body 53.

According to the eighth feature, in the wire harness 1 as described by any one of the first to third features, the plurality of large-diameter wires 2 and the at least one multicore wire 4, 9 of the twisted body 10, 11 are untwisted on an end side relative to the portion housed in the holder 5, 5A, 5B, 5C, and wherein the plurality of large-diameter wires 2 and the at least one multicore wire 4, 9 on the end side relative to the holder 5, 5A, 5B, 5C comprise a portion remaining twisted together at least at an end on the holder 5, 5A, 5B, 5C side.

Although the embodiments of the invention have been described, the invention according to claims is not to be limited to the embodiments described above. Further, please note that not all combinations of the features described in the embodiments are necessary to solve the problem of the invention.

In addition, the invention can be appropriately modified and implemented without departing from the gist thereof. For example, although the example in which the holders 5 are fixed to the attachment target members 86, 87 has been described in the above first embodiment, it is not limited thereto and the holders may simply hold the plural power lines 2 and the multicore wire 4. In addition, although the example in which the plural power lines 2 supply operating power to the electric braking device 72 and the plural signal lines 3 transmit the detection signal of the physical quantity sensor 631 serving as a wheel speed sensor has been described in the first embodiment, the uses of the large-diameter wire and the small-diameter wire of the invention are not limited thereto. For example, the large-diameter wire of the invention may be used for power supply, etc., to a device other than the braking device 72, or the small-diameter wire of the invention may be used to, e.g., transmit a signal for controlling the electric braking device 72 or may be used as a power line or signal line for an electronic component such as a sensor other than the wheel speed sensor. The insulation 22 of each of the plural power lines 2 and the sheath 40 of the multicore wire 4 may be configured such that at least the outermost layer is made of a rubber such as EPDM (ethylene propylene diene rubber), butyl rubber, butadiene rubber, silicone rubber, etc.

1. A wire harness, comprising:
a plurality of large-diameter wires;
at least one multicore wire in which a plurality of small-diameter wires having a smaller outer diameter than the plurality of large-diameter wires are collectively covered with a sheath; and
a holder to hold the plurality of large-diameter wires and the at least one multicore wire,
wherein the plurality of large-diameter wires and the plurality of small-diameter wires are each formed by covering a conductor with an insulation,
wherein the plurality of large-diameter wires and the at least one multicore wire are twisted together to form a twisted body,
wherein the twisted body comprises a portion in a longitudinal direction housed in the holder, and a portion not housed in the holder at which the plurality of large-diameter wires and the at least one multicore wire are exposed,
wherein a length of a portion where the twisted body is housed in the holder is smaller than a length of a portion where the plurality of large-diameter wires and the at least one multicore wire are exposed, and
wherein the insulation of each of the plurality of large-diameter wires and the sheath are in contact with each other at the portion housed in the holder.

2. The wire harness according to claim 1, wherein the insulation of each of the plurality of large-diameter wires and the sheath have an outer circumferential surface with a surface roughness Ra of 1 μm or more.

3. The wire harness according to claim 1, wherein the plurality of small-diameter wires of the at least one multicore wire are twisted together inside the sheath, and wherein a twisting direction of the plurality of small-diameter wires is the same as a twisting direction of the plurality of large-diameter wires and the at least one multicore wire in the twisted body.

4. The wire harness according to claim 1, wherein an outer diameter of each of the plurality of large-diameter wires is approximately the same as an outer diameter of the at least one multicore wire.

5. The wire harness according to claim 1, wherein the holder comprises a tightening member that tightens on the twisted body.

6. The wire harness according to claim 1, wherein the holder comprises a resin tube that surrounds the twisted body, and a tightening member that tightens on the resin tube.

7. The wire harness according to claim 1, wherein the holder comprises a resin molded body comprising holding holes formed to penetrate therethrough to respectively hold the plurality of large-diameter wires and the at least one multicore wire, and a tightening member that tightens on the resin molded body.

8. The wire harness according to claim 1, wherein the plurality of large-diameter wires and the at least one multicore wire of the twisted body are untwisted on an end side relative to the portion housed in the holder, and wherein the plurality of large-diameter wires and the at least one multicore wire on the end side relative to the holder comprise a portion remaining twisted together at least at an end on the holder side.

9. The wire harness according to claim 1, wherein in the insulation of each of the plurality of large-diameter wires and the sheath, at least an outermost layer comprises a polyurethane-based resin.
